(19) United States
(12) Patent Application Publication
(10) Pub. No.: US 2025/0247402 A1
(43) Pub. Date: Jul. 31, 2025

(54) MALICIOUS ACTIVITY DETECTION OPERATION GENERATION

(71) Applicant: Google LLC, Mountain View, CA (US)

(72) Inventor: Anurag Singla, Cupertino, CA (US)

(21) Appl. No.: 18/425,505

(22) Filed: Jan. 29, 2024

(51) Int. Cl. H04L 9/40

(52) U.S. Cl. CPC H04L 63/1416

(57) ABSTRACT

A method includes obtaining a first attack sequence comprising at least a first attack phase, a second attack phase, and a third attack phase. The method further includes determining that a first number of alerts generated for the first attack phase based on a set of detection operations and a second number of alerts generated for the third attack phase based on the set of detection operations satisfy a threshold criterion. The method further includes determining that a third number of alerts generated for the second attack phase based on the set of detection operations fails to satisfy the threshold criterion. The method further includes determining that the set of detection operations is to be modified to detect future malicious activities corresponding to the second attack phase.

### TECHNICAL FIELD

Aspects and implementations of the present disclosure relate to computer security, and in particular to generating malicious activity detection operations with respect to computing devices.

### BACKGROUND

Computing devices such as data centers and cloud computing platforms may be susceptible to malicious activity (e.g., malware, network-based attacks). Malicious activity can lead to interruption or inefficient operation of computing devices, which can be problematic for owners and operators of computing devices. In extreme cases, malicious activity can damage computing devices or data stored thereon, potentially causing substantial financial loss and other losses and liabilities for the owners and operators of computing devices.

Security platforms typically have malicious activity notification mechanisms in place that alert clients when potential malicious activity is detected. The malicious activity can then be mitigated, e.g., by blocking a malicious file from being downloaded, stopping malicious processes that are running, etc. Reviewing and acting on malicious activity alerts is often a manual and time-consuming process for security professionals, which can result in human errors and can strain the human resources of security teams, thereby decreasing the overall effectiveness and threat coverage of the security platform.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

In some implementations, a system and method are disclosed for malicious activity detection operation generation. In an implementation, a method includes obtaining a first attack sequence comprising at least a first attack phase, a second attack phase, and a third attack phase. The method further includes determining that a first number of alerts generated for the first attack phase based on a set of detection operations and a second number of alerts generated for the third attack phase based on the set of detection operations satisfy a threshold criterion. The method further includes determining that a third number of alerts generated for the second attack phase based on the set of detection operations fails to satisfy the threshold criterion. The method further includes determining that the set of detection operations is to be modified to detect future malicious activities corresponding to the second attack phase.

In some embodiments, determining that the first number of alerts generated for the first attack phase based on the set of detection operations and the second number of alerts generated for the third attack phase based on the set of detection operations satisfy the threshold criterion includes obtaining a plurality of generated alerts including at least a first alert and a second alert, associating the first alert with the first attack phase based on one or more properties of the first alert, and associating the second alert with the third attack phase based on one or more properties of the second alert.

In some embodiments, the method further includes modifying the set of detection operations and detecting, based on the modified set of detection operations, malicious activity associated with the second attack phase.

In some embodiments, determining that the set of detection operations is to be modified includes identifying within event logs one or more events associated with the second attack phase. In some embodiments, identifying within event logs the one or more events associated with the second attack phase includes at least one of identifying a first event with a first event metadata value that satisfies a magnitude criterion or identifying a second event with a second event metadata value that satisfies a baseline-deviation criterion.

In some embodiments, the first attack sequence is associated with a first entity. In some embodiments, identifying within event logs the one or more events associated with the second attack phase includes obtaining an external alert associated with a second entity, the external alert having an associated external event, and identifying a third event of the first entity with a third event metadata value that matches a corresponding event metadata value of the external event.

In some embodiments, the set of detection operations is based at least on a first malicious activity detection rule corresponding to the first attack phase and a second malicious activity detection rule corresponding to the third attack phase. In some embodiments, the method further includes modifying the set of detection operations by adding a third malicious activity detection rule corresponding to the second attack phase, the third malicious activity detection rule being based on the identified one or more events. In some embodiments, the third malicious activity detection rule is generated by applying a trained machine learning model to the identified one or more events to obtain a machine learning output, the machine learning output representing the third malicious activity detection rule.

In some embodiments, the set of detection operations is based at least on a first machine learning model trained to identify malicious activity associated with the first attack phase and a second machine learning model trained to identify malicious activity associated with the third attack phase. In some embodiments, the method further includes modifying the set of detection operations by adding a third machine learning model trained to identify malicious activity associated with the second attack phase, wherein the third machine learning model is trained using the identified one or more events.

In some embodiments a computer-readable storage medium (which may be a non-transitory computer-readable storage medium, although the invention is not limited to that) stores instructions which, when executed, cause a processing device to perform operations comprising a method according to any embodiment or aspect described herein.

In some embodiments a system comprises: a memory device; and a processing device operatively coupled with the memory to perform operations comprising a method according to any embodiment or aspect described herein.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system for malicious activity detection operation generation, in accordance with at least one embodiment.

FIG. 2 depicts an example attack sequence with corresponding alerts, in accordance with at least one embodiment.

FIG. 3 depicts a flow diagram of an example method of malicious activity detection operation generation, in accordance with at least one embodiment.

FIG. 4 is a block diagram illustrating an exemplary computer system, in accordance with at least one embodiment of the present disclosure.

### DETAILED DESCRIPTION

Threat indicators may indicate past or current malicious activities with respect to computing resources. Computing resources may include, for example, servers, data centers, and cloud computing resources. Various computing resources may be susceptible to malicious activity. Examples of malicious activity include installation or operation of malware (e.g., malicious software), accessing or attempting to access computing resources without permission or authorization, modifying or exfiltrating data stored on computing resources without permission or authorization, exhausting computing resources (e.g., a denial-of-service attack), and other forms of unwanted activity. Malicious activity is often problematic for owners and operators of computing resources because the malicious activity can lead to interruption or inefficient operation of computing resources, or in extreme cases, substantial financial loss and liabilities. Malware is used herein as an example of malicious activity, but malicious activity often involves many other components such as those mentioned above, which are also within the scope of the present disclosure.

A security platform may provide services for detecting malicious activity with respect to computing resources, enabling timely mitigation before the malicious activity causes significant harm. For example, a security platform may receive data from computing resources (e.g., system event logs or new files inbound from a network connection) and analyze the data for signs of malicious activity. Detection operations may detect malicious activities based on the data received from computing resources. Detection operations may include detection rules and machine learning models trained to detect malicious activities. Detection rules may associate patterns in the data with different types of malicious activity, and rule evaluation engines may evaluate rules on new data. Upon evaluating a rule and detecting potential malicious activity, or upon detecting potential malicious activity using a trained machine learning model, the security platform can issue an alert to the computing resources (e.g., via an application programming interface (API)) or to the owners and operators of the computing resources (e.g., via email). The malicious activity can then be automatically or manually mitigated in a timely manner, such as by blocking a malicious file from being downloaded, stopping malicious processes that are running, etc. Security information and event management (SIEM) products are examples of security platforms and may include software, hardware, and managed service components.

Malicious activities can be related to one another. For example, multiple malicious activities may be related to a single malicious attack (e.g., a sequence of related malicious activities). Malicious activities of a single malicious attack may originate from the same malicious actor or may be directed to the same computing resources. Malicious activities of a malicious attack can be grouped based on an attack phase the malicious activity corresponds to. Possible attack phases can include a reconnaissance phase, an initial access phase, a lateral movement phase, a data collection phase, an exfiltration phase, and the like. The malicious activities of an attack often follow predictable sequences. For example, malicious activity associated with a reconnaissance phase of the attack often occurs before malicious activity related to an initial access phase of the attack or a lateral movement phase of the attack. Different malicious attacks may follow different malicious attack sequences (e.g., not all attack sequences will have malicious activity associated with every attack phase), but the sequences may follow a similar order (e.g., malicious activities corresponding to a reconnaissance phase may always come before malicious activities corresponding to an exfiltration phase).

In conventional security platforms, detection operations may exist for some attack phases but not all attack phases. The security platform may not identify attack phases that do not have corresponding detection operations (e.g., may not have rules defined to detect a relevant type of malicious activity). Malicious activity corresponding to those attack phases may go undetected if there are not corresponding detection operations.

Aspects of the present disclosure address the above and other deficiencies by providing frameworks for malicious activity detection operation generation. For example, after a set of alerts have been generated related to an attack, the alerts may be assigned to one or more attack phases (e.g., reconnaissance, initial access, lateral movement, data collection, exfiltration, etc.). A security platform (e.g., SIEM system) may identify attack phases of an attack sequence that do not have any associated alerts. Attack phases without associated alerts may indicate that malicious activity occurred and was not detected. For example, data collection often occurs before exfiltration. If alerts identifying exfiltration events were generated but no alerts identifying preceding data collection events were generated, a new detection operation (e.g., based on a new detection rule, new or retained detection machine learning model, etc.) may need to be generated to detect the data collection event(s) that occurred before the detected exfiltration event(s).

The security platform may search system logs for data collection events and may filter the events based on the size of their impact (e.g., large amount of data transferred) or based on a deviation from a baseline (e.g., user logging in at an unusual time or from an unusual place) to determine which data collection events are malicious and which are non-malicious. In some embodiments, alerts for the missing attack phase from another organization (e.g., an organization in a similar industry, an organization of a similar size, an organization with similar revenue, etc.) may be used to identify malicious events that may have occurred. Based on the identified events, a new detection operation may be generated. In some embodiments, a new detection rule may be generated using a generative artificial intelligence (AI) model. In some embodiments, a detection machine learning model may be trained to recognize events similar to the identified events.

Advantages of the disclosed embodiments over the existing technology include but are not limited to improved detection of malicious activities with respect to computing devices, resulting in reduced misuse of computing resources. Thus, a security platform and/or computing resources of an entity may experience reduced operating costs and improved latency and throughput, which may benefit clients as well as increase trust in the security platform.

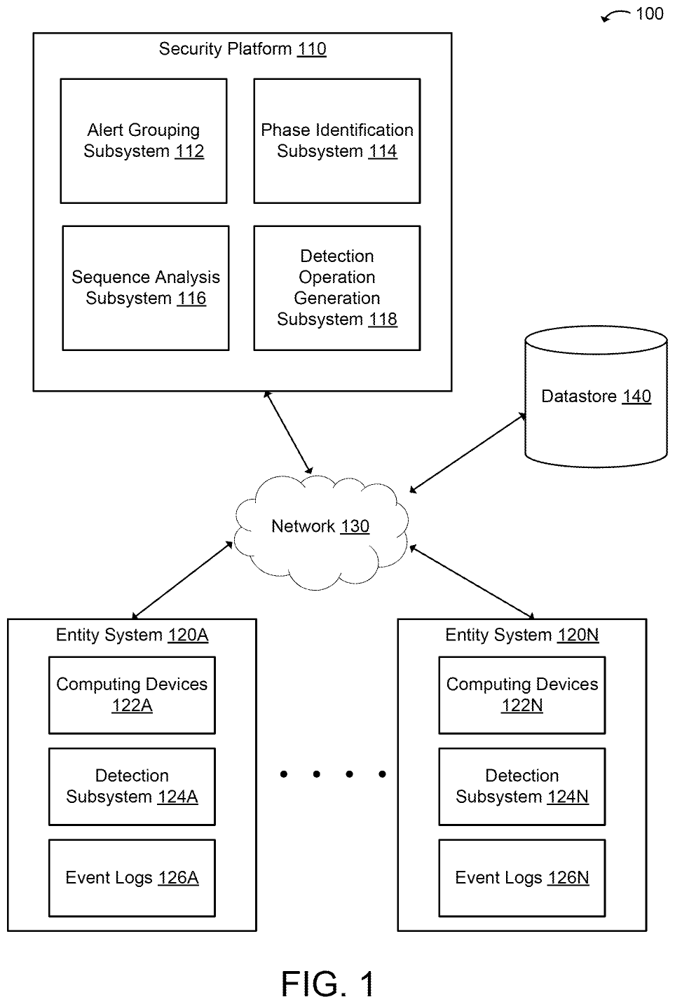

FIG. 1 illustrates an example system 100 for malicious activity detection operation generation, in accordance with at least one embodiment. System 100 may include security platform 110, one or more organizations 120A-N, and datastore 140 connected to network 130, such as a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

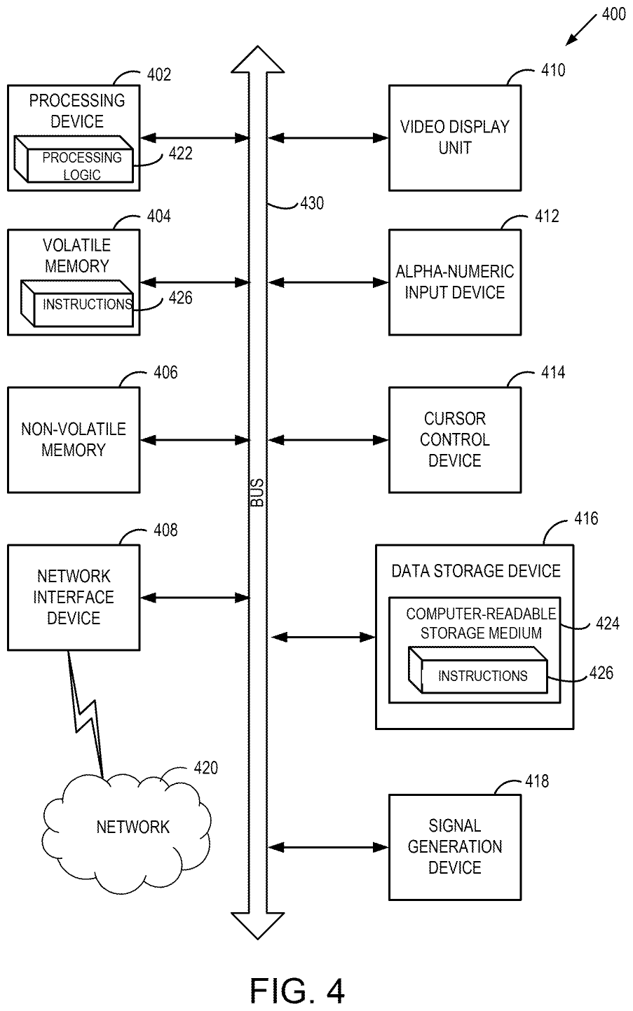

Entity systems 120A-N may each include computing resources of an entity (e.g., an organization) such as computing devices 122A-N, and detection subsystem 124A-N. Computing devices 122A-N may include one or more processing devices, volatile and non-volatile memory, data storage, one or more input/output peripherals such as network interfaces. FIG. 4 illustrates an example architecture of computing devices. In some embodiments, computing devices 122A-N may be singular devices such as smartphones, tablets, laptops, desktops, workstations, edge devices, embedded devices, servers, network appliances, security appliances, etc. In some embodiments, computing devices 122A-N may comprise multiple devices of similar or varying architecture such as computing clusters, data centers, co-located servers, enterprise networks, geographically disparate devices connected via virtual private networks (VPNs), etc. In some embodiments, computing devices 122A-N may comprise hardware devices such as those just described, virtual resources such as virtual machines (VMs) and containerized applications, or a combination of hardware and virtual resources.

Detection subsystem 124A-N may include one or more detection rules and/or detection models trained to identify malicious activity. Detection subsystem 124A-N may read system logs and/or other data sources (e.g., event logs 126A-N) to identify potential malicious activity. Upon detecting malicious activity, detection subsystem 124A-N may generate an alert based on the configured detection rule and/or detection model that identified the malicious activity. In some embodiments, detection subsystem 124A-N is part of entity system 120A-N and has access to event logs 126A-N. In some embodiments, entity system 120A-N provides event logs 126A-N to security platform 110 and detection subsystem 124A-N is part of security platform 110.

In some embodiments, entity system 120A-N is part of an entity's data center that includes computing devices 122A-N. Detection subsystem 124A-N can be part of the entity's data center or be located outside of the entity's data center (e.g., in a cloud computing environment). In other embodiments, entity system 120A-N is a part of a cloud computing environment having computing devices 122A-N assigned to the entity, and including detection subsystem 124A-N.

Security platform 110 can provide services for malicious activity detection operation generation with respect to computing resources of entity systems 120A-120N. Security platform 110 may include alert grouping subsystem 112, phase identification subsystem 114, sequence analysis subsystem 116, and detection operation generation subsystem 118. Alert grouping subsystem 112 may group alerts that are part of the same malicious attack. Each alert may include one or more attributes, such as a severity level, a confidence level, a risk level, malicious activity metadata, and the like. In some embodiments, alerts are grouped based on their attributes. For example, alerts may be grouped based on malicious activity metadata associated with each alert. The malicious activity metadata may include information about the origin of the malicious activity, the target of the malicious activity, a username associated with the malicious activity, a timestamp of the malicious activity, and the like. Alerts with the same (or similar) attributes may be grouped together into a malicious attack.

Phase identification subsystem 114 may receive a group of alerts and identify one or more attack phases for each alert. In some embodiments, each alert may include, at the time of creation, a property that identifies one or more attack phases of the malicious activity associated with the alert. For example, if an alert is associated with a malicious activity that often occurs during a lateral movement phase of an attack, the alert may have an attribute identifying “lateral movement” as the attack phase of the attribute. In some embodiments, phase identification subsystem 114 may modify the attributes of an alert and assign one or more attack phases to the alert based on one or more properties of the alert. In some embodiments, the attack phases correspond to tactics (or phases) of a security attack framework (e.g., MITRE ATT&CK).

Sequence analysis subsystem 116 may receive the alerts with identified attack phases and group the alerts within the attack phases of a given attack sequence. Sequence analysis subsystem 116 may identify, for each attack phase, a number of alerts associated with the phase, a time of the first alert in the phase, a time of the last alert in the phase, and any significant time gaps (e.g., time gaps that exceed a time gap threshold criterion) between alerts in the phase. If any attack phase has a number of alerts that fails to satisfy a threshold criterion (e.g., 1, 2, 3, etc.), sequence analysis subsystem 116 may search event logs (e.g., event logs 126A-N) for events that identify malicious activities that correspond to that attack phase. In some embodiments, sequence analysis subsystem 116 may search event logs for events that identify malicious activities that correspond to any attack phase that has one (or more) significant time gaps between alerts in the phase. For example, if the number of significant time gaps between alerts in a phase satisfies a time gap criterion, security platform 110 may search event logs from times in the one or more time gaps to identify any malicious activities that occurred that correspond to the attack phase.

Sequence analysis subsystem 116 may search event logs for events that identify potentially malicious activities that correspond to an attack phase with a number of alerts that failed to satisfy the threshold criterion (e.g., “target attack phase”). In some embodiments, event logs are provided to security platform 110 (e.g., from organizations 120A-N). In some embodiments, sequence analysis subsystem 116 is part of entity system 120A-N and can analyze event logs within entity system 120A-N. Sequence analysis subsystem 116 may identify possible events that may be related to malicious activity associated with the target attack phase. For example, if alerts were detected in an exfiltration phase but no alerts (or alerts less than the threshold criterion) were detected in a data collection phase, the target attack phase may be the data collection phase (e.g., back tracking). Sequence analysis subsystem 116 may search for download events by the user and/or devices associated with the malicious activities of the exfiltration alerts. As another example, if alerts were detected in an initial access phase, an execution phase, and/or a discovery phase but no alerts were detected in a lateral movement phase, the target attack phase may be the lateral movement phase (e.g., forward tracking). Sequence analysis subsystem 116 may search for authorization events by the user and/or devices associated with the malicious activities of the initial access, execution, and/or discovery alerts.

After identifying possible events, sequence analysis subsystem 116 may analyze metadata values of the events. For example, sequence analysis subsystem 116 may determine that an event with a metadata value that satisfies a magnitude criterion (e.g., a large number of bytes downloaded, high frequency of login attempts, etc.) is a malicious activity. In some embodiments, sequence analysis subsystem 116 may determine that an event with a metadata value that satisfies a baseline-deviation criterion is a malicious activity. For example, if the event indicates that a user logged in to a system at an unusual time, that a user logged in from an unusual location, that the user started a process, that a process executed another (uncommon) process, that a device connected to a machine it does not typically connect to, and the like, sequence analysis subsystem 116 may determine that the event is a malicious activity.

In some embodiments, sequence analysis subsystem 116 may search for alerts (e.g., an external event) associated with the target attack phase in a second entity. In some embodiments, the second entity is similar to (e.g., is in a similar industry vertical, has a similar number of users, has similar revenue, etc.) the first entity associated with the attack sequence. The external alerts may have associated external events and/or external malicious activities. Sequence analysis subsystem 116 may identify an external event associated with an external alert associated with the target attack phase. Sequence analysis subsystem 116 may search the event logs of the first entity to identify an event that is similar to the external event (e.g., based on one or more matching event metadata values) and may identify the event as a malicious activity.

Detection operation generation subsystem 118 may receive the identified events from sequence analysis subsystem 116. In some embodiments, detection operation generation subsystem 118 may apply a trained AI model (e.g., a trained machine learning model, a generative AI model) to the identified events to obtain a model output that represents a malicious activity detection rule. The generated malicious activity detection rule may detect future events similar to the identified events and may cause an alert to be generated so the future malicious activity is detected. In some embodiments, detection operation generation subsystem 118 may train a detection model (e.g., an AI model capable of detecting malicious activity based on event logs) based on the identified events. The trained detection model may detect future events similar to the identified events and may cause an alert to be generated so the future malicious activity is detected. In some embodiments, the detection model may be a neural network auto encoder or a recurrent neural network.

In some embodiments, the detection operations (e.g., detection rules, detection AI models) generated by detection operation generation subsystem 118 may modify a set of detection operations of a detection subsystem (e.g., detection subsystem 124A-N).

As discussed, security platform 110 and the components thereof (e.g., alert grouping subsystem 112, phase identification subsystem 114, sequence analysis subsystem 116, and detection operation generation subsystem 118) may include one or more AI models. The AI models can include one or more of decision trees, random forests, support vector machines, or other types of machine learning models. In one embodiment, such AI models may include one or more artificial neural networks (also referred to simply as a neural network). The artificial neural network can include a feature representation component with a classifier or regression layers that map features to a target output space. The artificial neural network may be, for example, a convolutional neural network (CNN) that can include a feature representation component with a classifier or regression layers that map features to a target output space, and can host multiple layers of convolutional filters. Pooling can be performed, and non-linearities may be addressed, at lower layers, on top of which a multi-layer perceptron can be commonly appended, mapping top layer features extracted by the convolutional layers to decisions (e.g., classification outputs). The neural network may further be a deep network with multiple hidden layers or a shallow network with zero or a few (e.g., 1-2) hidden layers. Deep learning may use a cascade of multiple layers of nonlinear processing units for feature extraction and transformation. Each successive layer can use the output from the previous layer as input. In deep learning, each level learns to transform its input data into a slightly more abstract and composite representation.

In some embodiments, the AI models may include one or more recurrent neural networks (RNNs). An RNN is a type of neural network that includes a memory to enable the neural network to capture temporal dependencies. An RNN is able to learn input-output mappings that depend on both a current input and past inputs. The RNN can address past and future measurements and make predictions based on this continuous measurement information. One type of RNN that may be used is a long short term memory (LSTM) neural network.

The AI models can include at least one generative AI model, such as a large language model (LLM) allowing for the generation of new and original content. A generative AI model may include aspects of a transformer architecture, or a generative adversarial network (GAN) architecture. Such a generative AI model can use other machine learning models including an encoder-decoder architecture including one or more self-attention mechanisms, and one or more feed-forward mechanisms. In some embodiments, the generative AI model can include an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. A generative AI model can also utilize the previously discussed deep learning techniques, including recurrent neural networks (RNNs), convolutional neural networks (CNNs), or transformer networks. A generative AI model can be pre-trained on a large corpus of data so as to process, analyze, and generate human-like text based on given input. Any of the AI models may have any typical architecture for LLMs, including one or more architectures as seen in Bidirectional Encoder Representations from Transformers (BERT), Generative Pre-trained Transformer series (Chat GPT series LLMs), or leverage a combination of transformer architecture with pre-trained data to create coherent and contextually relevant text.

The AI models can be trained using training data. In embodiments, system 100 can include a training set generator that is capable of generating training data (e.g., a set of training inputs and a set of target outputs) to train the AI models. Training data can be associated with training an AI model to generate a response to a user query based on any combination of metadata, question language, the subtitle text corresponding to a video, and/or external information (not shown in FIG. 1). In embodiments, the user query may be formed in natural language.

The training set generator can accept responses as training input data to generate a training corpus for the AI model(s). The training set generator (or another component of system 100) can store the generated corpus of training data at datastore 140. In some implementations, the training set generator can generate training data that can be used to refine an already trained model. In some implementations, the training set generator can generate training data that can be used to train an LLM. In some implementations, training input data can be populated with historical variations of data. In some implementations, the training set generator can attach various training labels to training input data used to generate training data.

In some implementations, model training can be supervised, and each set of training data can include a subset of training inputs and target outputs based on the identified data. To train a supervised model, the training set generator can generate training data including a subset of training inputs and a subset of target outputs. The subset of training inputs can include questions, and a subset of target outputs can include responses (which in some cases may be textual responses). In some implementations, a subset of training inputs can include responses and a subset of target outputs can include a question. In some implementations, the training set generator can include an LLM that accepts responses and generates similar descriptions based on the input of the responses for a particular question. In some implementations, model training can be unsupervised. To train an unsupervised model, the training set generator can generate training data by clustering groups of historical responses (e.g., included in datastore 140) based on similarities between the historical responses, through dimensionality reduction by reducing the number of features in the data while retaining as much relevant information about the historical responses as possible, by generating synthetic or partially synthetic data that resembles the original data, through anomaly detection by identifying parts of content items that are significantly different from the rest of the data, or through data augmentation by applying mathematical transformations to the training dataset.

In some embodiments, system 100 may include a training engine. The training engine can train an AI model using the training data from the training set generator. In some implementations, the AI model(s) can refer to the model artifact that is created by the training engine using the training data that includes training inputs and corresponding target outputs (correct answers for respective training inputs). The training engine can find patterns in the training data that map the training input to the target output (the answer to be predicted), identify clusters of data that correspond to the identified patterns, and provide the AI model(s) that captures these patterns. For example, the AI model(s) can be trained by adjusting weights of a neural network in accordance with a backpropagation learning algorithm or the like. The AI model(s) can use one or more of support vector machine (SVM), Radial Basis Function (RBF), clustering, supervised machine learning, semi-supervised machine learning, unsupervised machine learning, k-nearest neighbor algorithm (k-NN), linear regression, random forest, neural network (e.g., artificial neural network), a boosted decision forest, etc.

In some implementations, the training engine can train the AI models using a generative adversarial network (GAN). A GAN can consist of two neural networks, where one neural network is a generative AI model, and the other neural network is a discriminative AI model. GAN can cause each of the two neural networks to engage in a competitive process against the other neural network. The generative AI model can attempt to synthesize data that is indistinguishable from collected data (e.g., input data to the generative AI model), and the discriminative AI model can attempt to differentiate between collected data and synthesized data. GAN training can iteratively refine the output of the generative AI model to align to the collected dataset more closely. In some implementations, the training engine can train the AI models using a variational autoencoder (VAE), which can introduce probabilistic encoding to represent input data. The probabilistic encoding can be processed through one or more layers and then decoded to reconstruct a generative output. In this way, VAE can be used to train the AI models to learn latent configurable representations of data (e.g., the probabilistic encoding through various layers). Output from the AI models trained using VAE can be continuously reconfigured based on the latent configurable representations of data.

Datastore 140 may be a persistent storage that is capable of storing malicious activities and/or associated metadata, event logs, alerts and/or associated metadata, AI models, detection rules, attack sequences, and the like. Datastore 140 may be hosted by one or more storage devices, such as main memory, magnetic or optical storage-based disks, tapes or hard drives, network attached storage (NAS), storage area network (SAN), and so forth. In some embodiments, datastore 140 may be a network-attached file server. In some embodiments, datastore 140 may be some other type of persistent storage such as an object-oriented database, a relational database, and so forth. In some embodiments, datastore 140 may be hosted on or may be a component of security platform 110. In some embodiments, datastore 140 may be provided by a third-party service such as a cloud platform provider.

In implementations of the disclosure, a “user” can be represented as a single individual. However, other implementations of the disclosure encompass a “user” being an entity controlled by a set of users or an organization and/or an automated source such as a system or a platform. In situations in which the systems discussed here collect personal information about users, or can make use of personal information, the users can be provided with an opportunity to control whether security platform 110 and detection subsystems 124A-N collect user information (e.g., information about a user's social network, social actions or activities, profession, a user's preferences, or a user's current location), or to control whether and/or how to receive content from the security platform 110 and detection subsystems 124A-N that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the security platform 110 and detection subsystems 124A-N.

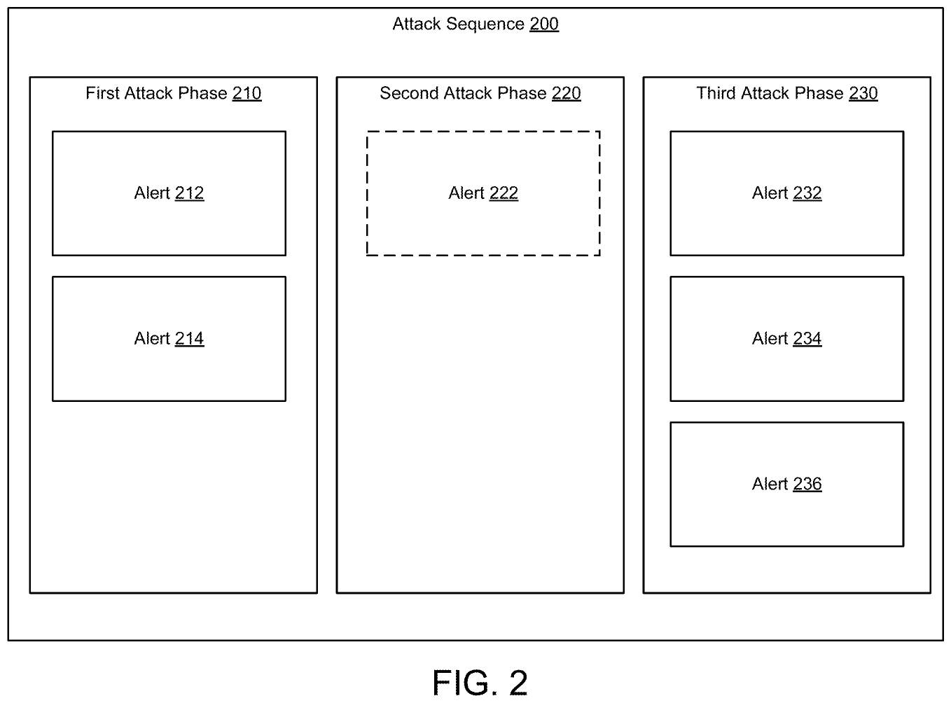

FIG. 2 depicts an example attack sequence 200 with corresponding alerts 212, 214, 222, 232, 234, and 236, in accordance with at least one embodiment. Attack sequence 200 may include one or more attack phases, such as first attack phase 210, second attack phase 220, and third attack phase 230. In some embodiments, attack sequence 200 may include more (or fewer) attack phases. Each of first attack phase 210, second attack phase 220, and third attack phase 230 may correspond to a different attack phase of a malicious attack. For example, first attack phase 210 may correspond to a reconnaissance phase of a malicious attack. Second attack phase 220 may correspond to a data collection phase of a malicious attack. Third attack phase 230 may correspond to an exfiltration phase of a malicious attack. The alerts of attack sequence 200 (e.g., alert 212, alert 214, alert 222, alert 232, alert 234, and alert 236) may be associated with one or more attack phases based on one or more properties of the alert. In some embodiments, an alert is associated with only one attack phase. In some embodiments, an alert is associated with more than one phase.

First attack phase 210 may include one or more alerts, such as alert 212 and alert 214, which correspond to malicious activities of the same attack phase (e.g., a reconnaissance phase) of a malicious attack. Each of alert 212 and alert 214 (and alert 222, alert 232, alert 234, and alert 236) may have one or more properties and may correspond to a malicious activity. In some embodiments, the properties of an alert (e.g., alert 212) may be based on the malicious activity corresponding to the alert. In some embodiments, an alert (e.g., alert 212) may correspond to an event (e.g., an event from an event log). In some embodiments, the event indicates malicious activity. In some embodiments, the event has metadata values that describe the event (e.g., filename, file size, origin computing resource, target computing resource, username, timestamp, etc.).

Third attack phase 230 may include one or more alerts, such as alert 232, alert 234, and alert 236, which correspond to malicious activities of the same attack phase (e.g., an exfiltration phase) of a malicious attack. Alerts 232, alert 234, and alert 236 may be grouped into third attack phase 230 based on one or more properties of each of the alerts. For example, each alert may have an alert property associated with exfiltrating data (e.g., to a device outside of an organization) from a monitored computing resource.

In some embodiments, second attack phase 220 may include alert 222 (depicted with a dashed border) corresponding to a second attack phase of a malicious attack. In some embodiments, second attack phase 220 may include more than one alert. In some embodiments, second attack phase 220 does not include any alerts. If the number of alerts in second attack phase 220 does not satisfy a threshold criterion (e.g., 0, 1, 2), a security platform (e.g., security platform 110 of FIG. 1) may search for events (e.g., using event logs) that correspond to potentially malicious activities that correspond to the second attack phase of the malicious attack and may generate detection operation(s) to detect similar events in the future.

In some embodiments, attack sequence 200 includes fewer (e.g., 2) attack phases. In some embodiments, alerts are missing in a future attack phase (e.g., first attack phase 210 includes alerts but second attack phase 220 does not). In some embodiments, alerts are missing in a past attack phase (e.g., second attack phase 220 includes alerts but third attack phase 230 does not). In each case, events logs may be analyzed to determine if malicious activity corresponding to the attack phase without corresponding alerts was undetected.

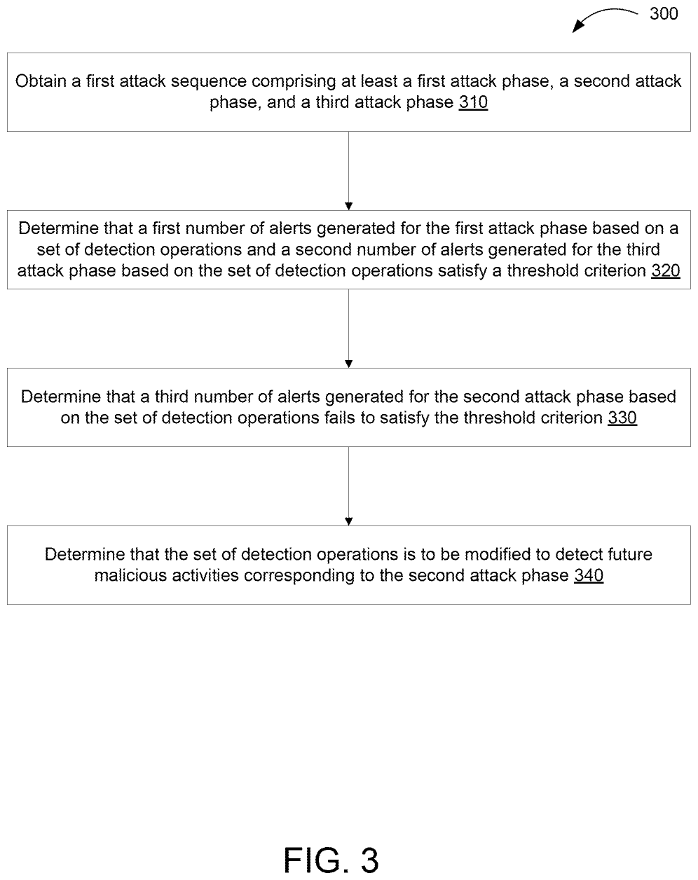

FIG. 3 depicts a flow diagram of an example method 300 of malicious activity detection operation generation, in accordance with at least one embodiment. Method 300 can be performed by processing logic that can include hardware (circuitry, dedicated logic, etc.), software (e.g., instructions run on a processing device), or a combination thereof. In at least one implementation, some or all of the operations of method 300 can be performed by one or more components of system 100 for malicious activity detection operation generation of FIG. 1.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states e.g., via a state diagram. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

At block 310, processing logic may obtain a first attack sequence comprising at least a first attack phase, a second attack phase, and a third attack phase.

At block 320, processing logic may determine that a first number of alerts generated for the first attack phase based on a set of detection operations and a second number of alerts generated for the third attack phase based on the set of detection operations satisfy a threshold criterion.

In some embodiments, to determine that the first number of alerts generated for the first attack phase based on the set of detection operations and the second number of alerts generated for the third attack phase based on the set of detection operations satisfy the threshold criterion, processing logic may obtain a plurality of generated alerts comprising at least a first alert and a second alert. Processing logic may further associate the first alert with the first attack phase based on one or more properties of the first alert. Processing logic may further associate the second alert with the third attack phase based on one or more properties of the second alert.

At block 330, processing logic may determine that a third number of alerts generated for the second attack phase based on the set of detection operations fails to satisfy the threshold criterion. In some embodiments, the threshold criterion is 1. In some embodiments, the threshold criterion is 0. In some embodiments, another value is used as the threshold criterion.

At block 340, processing logic may determine that the set of detection operations is to be modified to detect future malicious activities corresponding to the second attack phase. In some embodiments, processing logic may further modify the set of detection operations and may detect, based on the modified set of detection operations, malicious activity associated with the second attack phase. In some embodiments, to determine that the set of detection operations is to be modified, processing logic may identify within event logs one or more events associated with the second attack phase. In some embodiments, to identify within event logs one or more events associated with the second attack phase, processing logic may identify a first event with a first event metadata value that satisfies a magnitude criterion. In some embodiments, processing logic may identify a second event with a second event metadata value that satisfies a baseline-deviation criterion.

In some embodiments, the first attack sequence is associated with a first entity. Processing logic may, to identify within event logs the one or more events associated with the second attack phase, obtain an external alert associated with a second entity. The external alert may have an associated external event. Processing logic may further identify a third event of the first entity with a third event metadata value that matches a corresponding event metadata value of the external event.

In some embodiments, the set of detection operations is based at least on a first malicious activity detection rule corresponding to the first attack phase and a second malicious activity detection rule corresponding to the third attack phase. In some embodiments, processing logic performing method 300 may further modify the set of detection operations by adding a third malicious activity detection rule corresponding to the second attack phase, the third malicious activity detection rule being based on the identified one or more events. In some embodiments, the third malicious activity detection rule is generated by applying a trained machine learning model to the identified one or more events to obtain a machine learning output. The machine learning output may represent the third malicious activity detection rule. In some embodiments, the trained machine learning model is a generative AI model.

In some embodiments. the set of detection operations is based at least on a first machine learning model trained to identify malicious activity associated with the first attack phase and a second machine learning model trained to identify malicious activity associated with the third attack phase. In some embodiments, processing logic performing method 300 may further modify the set of detection operations by adding a third machine learning model trained to identify malicious activity associated with the second attack phase. The third machine learning model may be trained using the identified one or more events.

FIG. 4 is a block diagram illustrating an exemplary computer system, in accordance with at least one embodiment of the present disclosure. The computer system 400 can correspond to security platform 110 and/or entity system 120A-N, described with respect to FIG. 1. Computer system 400 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processing device (processor) 402, a main memory 404 (e.g., read-only memory (ROM), flash memory, dynamic random access memory (DRAM) such as synchronous DRAM (SDRAM), double data rate (DDR SDRAM), or DRAM (RDRAM), etc.), a static memory 406 (e.g., flash memory, static random access memory (SRAM), etc.), and a data storage device 416, which communicate with each other via a bus 430.

Processor (processing device) 402 represents one or more general-purpose processing devices such as a microprocessor, central processing unit, or the like and may include processing logic 422. More particularly, the processor 402 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 402 can also be one or more special-purpose processing devices such as an application specific integrated circuit (ASIC), a field programmable gate array (FPGA), a digital signal processor (DSP), network processor, or the like. The processor 402 is configured to execute instructions 426 (e.g., for malicious activity detection operation generation) for performing the operations discussed herein.

The computer system 400 can further include a network interface device 408. The computer system 400 also can include a video display unit 410 (e.g., a liquid crystal display (LCD) or a cathode ray tube (CRT)), an input device 412 (e.g., a keyboard, and alphanumeric keyboard, a motion sensing input device, touch screen), a cursor control device 414 (e.g., a mouse), and a signal generation device 418 (e.g., a speaker). In some embodiments, computer system 400 may not include video display unit 410, input device 412, and/or cursor control device 414 (e.g., in a headless configuration).

The data storage device 416 can include a non-transitory machine-readable storage medium 424 (also computer-readable storage medium) on which is stored one or more sets of instructions 426 (e.g., for malicious activity detection operation generation) embodying any one or more of the methodologies or functions described herein. The instructions can also reside, completely or at least partially, within the main memory 404 and/or within the processor 402 during execution thereof by the computer system 400, the main memory 404 and the processor 402 also constituting machine-readable storage media. The instructions can further be transmitted or received over a network 420 via the network interface device 408.

In one implementation, the instructions 426 include instructions for malicious activity detection operation generation. While the computer-readable storage medium 424 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” “subsystem” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
obtaining a first attack sequence comprising at least a first attack phase, a second attack phase, and a third attack phase;
determining that a first number of alerts generated for the first attack phase based on a set of detection operations and a second number of alerts generated for the third attack phase based on the set of detection operations satisfy a threshold criterion;
determining that a third number of alerts generated for the second attack phase based on the set of detection operations fails to satisfy the threshold criterion; and
determining that the set of detection operations is to be modified to detect future malicious activities corresponding to the second attack phase.

2. The method of claim 1, wherein determining that the first number of alerts generated for the first attack phase based on the set of detection operations and the second number of alerts generated for the third attack phase based on the set of detection operations satisfy the threshold criterion comprises:
obtaining a plurality of generated alerts comprising at least a first alert and a second alert;
associating the first alert with the first attack phase based on one or more properties of the first alert; and
associating the second alert with the third attack phase based on one or more properties of the second alert.

3. The method of claim 1, further comprising:
modifying the set of detection operations; and
detecting, based on the modified set of detection operations, malicious activity associated with the second attack phase.

4. The method of claim 1, wherein the determining that the set of detection operations is to be modified comprises identifying within event logs one or more events associated with the second attack phase.

5. The method of claim 4, wherein the identifying within event logs the one or more events associated with the second attack phase comprises at least one of:
identifying a first event with a first event metadata value that satisfies a magnitude criterion; or
identifying a second event with a second event metadata value that satisfies a baseline-deviation criterion.

6. The method of claim 5, wherein the first attack sequence is associated with a first entity, and wherein the identifying within event logs the one or more events associated with the second attack phase further comprises:
obtaining an external alert associated with a second entity, the external alert having an associated external event; and
identifying a third event of the first entity with a third event metadata value that matches a corresponding event metadata value of the external event.

7. The method of claim 4, wherein the set of detection operations is based at least on a first malicious activity detection rule corresponding to the first attack phase and a second malicious activity detection rule corresponding to the third attack phase.

8. The method of claim 7, further comprising modifying the set of detection operations by adding a third malicious activity detection rule corresponding to the second attack phase, the third malicious activity detection rule being based on the identified one or more events.

9. The method of claim 8, wherein the third malicious activity detection rule is generated by applying a trained machine learning model to the identified one or more events to obtain a machine learning output, the machine learning output representing the third malicious activity detection rule.

10. The method of claim 4, wherein the set of detection operations is based at least on a first machine learning model trained to identify malicious activity associated with the first attack phase and a second machine learning model trained to identify malicious activity associated with the third attack phase.

11. The method of claim 10, further comprising modifying the set of detection operations by adding a third machine learning model trained to identify malicious activity associated with the second attack phase, wherein the third machine learning model is trained using the identified one or more events.

12. A system comprising:
a memory device; and
a processing device coupled to the memory device, the processing device to perform operations comprising:
obtaining a first attack sequence comprising at least a first attack phase, a second attack phase, and a third attack phase;
determining that a first number of alerts generated for the first attack phase based on a set of detection operations and a second number of alerts generated for the third attack phase based on the set of detection operations satisfy a threshold criterion;
determining that a third number of alerts generated for the second attack phase based on the set of detection operations fails to satisfy the threshold criterion; and
determining that the set of detection operations is to be modified to detect future malicious activities corresponding to the second attack phase.

13. The system of claim 12, wherein determining that the first number of alerts generated for the first attack phase based on the set of detection operations and the second number of alerts generated for the third attack phase based on the set of detection operations satisfy the threshold criterion comprises:
obtaining a plurality of generated alerts comprising at least a first alert and a second alert;
associating the first alert with the first attack phase based on one or more properties of the first alert; and
associating the second alert with the third attack phase based on one or more properties of the second alert.

14. The system of claim 12, further comprising:
modifying the set of detection operations; and
detecting, based on the modified set of detection operations, malicious activity associated with the second attack phase.

15. The system of claim 12, wherein the determining that the set of detection operations is to be modified comprises identifying within event logs one or more events associated with the second attack phase.

16. The system of claim 15, wherein the identifying within event logs the one or more events associated with the second attack phase comprises at least one of:
identifying a first event with a first event metadata value that satisfies a magnitude criterion; or
identifying a second event with a second event metadata value that satisfies a baseline-deviation criterion.

17. The system of claim 16, wherein the first attack sequence is associated with a first entity, and wherein the identifying within event logs the one or more events associated with the second attack phase further comprises:
obtaining an external alert associated with a second entity, the external alert having an associated external event; and
identifying a third event of the first entity with a third event metadata value that matches a corresponding event metadata value of the external event.

18. The system of claim 15, wherein the set of detection operations is based at least on a first malicious activity detection rule corresponding to the first attack phase and a second malicious activity detection rule corresponding to the third attack phase.

19. The system of claim 15, wherein the set of detection operations is based at least on a first machine learning model trained to identify malicious activity associated with the first attack phase and a second machine learning model trained to identify malicious activity associated with the third attack phase.

20. A non-transitory computer-readable storage medium comprising instruction that, when executed by a processing device, cause the processing device to perform operations comprising:
obtaining a first attack sequence comprising at least a first attack phase, a second attack phase, and a third attack phase;
determining that a first number of alerts generated for the first attack phase based on a set of detection operations and a second number of alerts generated for the third attack phase based on the set of detection operations satisfy a threshold criterion;
determining that a third number of alerts generated for the second attack phase based on the set of detection operations fails to satisfy the threshold criterion; and
determining that the set of detection operations is to be modified to detect future malicious activities corresponding to the second attack phase.
